(19) United States
(12) Patent Application Publication
(10) Pub. No.: US 2012/0008753 A1
(43) Pub. Date: Jan. 12, 2012

(54) SUPPORTING DOMAIN VARIATION WITHIN A CLOUD PROVIDED MULTITENANT UNIFIED COMMUNICATIONS ENVIRONMENT

(75) Inventors: Robert Burnett, Kansas City, MO (US); Michael Haines, Paola, KS (US); Calvin Pettiecord, Kearney, MO (US); Bryan DiGiorgio, Leawood, KS (US); Darren Molz, Gardner, KS (US); Scott Koerner, Shawnee, KS (US)

(73) Assignee: WORKSPACE COMMUNICATIONS LLC., Overland, KS (US)

(21) Appl. No.: 13/180,773

(22) Filed: Jul. 12, 2011

Related U.S. Application Data
(60) Provisional application No. 61/363,333, filed on Jul. 12, 2010.

(51) Int. Cl. H04M 1/658; G06F 15/16; H04M 11/00

(52) U.S. Cl. 379/88.17; 379/90.01; 709/206

(57) ABSTRACT

A computer-implemented method of email processing within a multitenant unified communications environment includes receiving, at a first email system component that is a sub-component of a unified communications system, an email that is addressed to a recipient by way of a delivery address that includes a first domain identifier. Based at least in part on the delivery address, a second delivery address associated with the user is identified. The second delivery address does not include the first domain identifier but does include a second domain identifier that is different than the first domain identifier. The email is automatically sent to the second delivery address.

### CROSS-REFERENCE TO RELATED APPLICATION

The present application is based on and claims the benefit of U.S. provisional patent application Ser. No. 61/363,333, filed Jul. 12, 2010, the content of which is hereby incorporated by reference in its entirety.

### BACKGROUND

Global communication carriers have broadly transitioned away from circuit switched communication technology to a packet-based architecture. This shift has made it such that data, voice and video can all be handled over a single IP network. This capability has driven significant developments in unified communications technology. Generally speaking, unified communications refers to an integration of multiple communication services into a single software application environment. The integrated services may include, but are not necessarily limited to, any combination of call control, presence, e-mail, instant messaging, voice, and/or web conferencing. A quality unified communications implementation enables members of an organization to conveniently communicate and collaborate, even when they are not physically in the same location.

Another service that may or may not be a part of a unified communications implementation is unified messaging. The distinction between unified communications and unified messaging is sometimes confused. Unified communications typically refers to both real-time and non-real-time delivery of communications, for example, based on preferences of a user initiating the communications. In contrast, unified messaging usually refers to an integration of different electronic messaging applications such that messages from several sources (e.g., e-mail, voice mail, and/or fax) are acquired and held for user retrieval at a later time from a single (or at least substantially unified) interface. It is generally true of both unified communications and unified messaging that their functionality is provided in a single (or at least substantially unified) interface made accessible from a variety of different devices. When unified communications encompasses unified messaging, the functionality of both is generally provided within a single (or at least substantially unified) interface.

Some organizations implement a unified communications scheme in a way that enables them to maintain close control of the related hardware and software infrastructure. This is sometimes referred to as an “on-premise” setup. This type of implementation usually requires a high initial capital investment and relatively high support costs for management, maintenance and updating.

An alternative to an on-premise setup is a completely hosted unified communications implementation. This type of setup may be referred to as a UCaaS (Unified Communications as a Service) implementation. In this case, a so-called cloud service provider typically maintains control of most or all of the core hardware and software, and then provides the unified communications functionality to users as a service over a network such as the Internet. A related client application may be installed on devices through which the communication services are delivered, but the service infrastructure is generally outside the control of the service recipient.

A “hybrid” solution falls somewhere in between an on-premise and a completely hosted unified communications implementation. In one example of a hybrid solution, the core unified communications hardware/software is distributed between an on-premise location controlled by a service recipient and a location controlled by the cloud service provider. In this case, the components hosted by the cloud service provider are configured to work in coordination with the on-premise components. This may be the best solution, for example, where an organization has made a significant investment in an existing communication sub-system (e.g., an email server and related functionality) that they do not want to abandon in favor of a similar system hosted by the cloud service provider. In this case, the functionality of the existing system is tied in as a sub-component of the overall unified communications implementation, thereby enabling a hybrid solution.

It can also be considered a hybrid solution when a third party service provider essentially operates as a sub-component of the overall unified communications implementation. For example, an organization may be very tied to an external, cloud based email service they do not want to abandon. In this case, the functionality of the hosted third party system may be tied in as a sub-component component of the overall unified communications implementation, thereby enabling a hybrid solution. A hybrid solution is theoretically possible regardless of the scheme of distribution of functionality across on-premise and service provider sources.

Many unified comminations service providers provide their services within in a single tenant environment—one in which the hardware and software are dedicated to users within a single user domain. For example, a large organization might contract with a unified communications service provider for setup of a dedicated on-premise, hosted or hybrid enterprise system solely for their organization. However, unified communications services can alternatively be provided in a multitenant environment—one in which at least some of the hardware and software functionality is shared by users from different user domains that are potentially in no way affiliated with one another. The different domains of users also may be completely unaware of one another despite the fact that they receive services from the same cloud source. At least one current provider of unified communications services even provides services within such a multi-tenant environment on a subscription fee basis, thereby enabling even small organizations to easily enjoy the benefits of unified communications without a costly, up-front capital equipment investment.

Providers of unified communications services in a multitenant environment can increase the scope of their customer base by being especially flexible in terms of having the capacity to create effective hybrid implementations. This enables them to cater to a larger customer base than that served by providers that specialize primarily in serving large enterprises. In order to be as competitive as possible, multitenant service providers will try to accommodate functionality provided by many different existing, on-premise or third party hosted sub-components. One option is to create, on a customized basis, a specialized unified communications solution for each and every particular on-premise or hosted third party sub-component encountered in the client marketplace. However, an ideal solution will be more universal and accommodate relatively simple integration with broad range of on-premise or third party hosted sub-components having similar but different characteristics.

### SUMMARY

A computer-implemented method of email processing within a multitenant unified communications environment includes receiving, at a first email system component that is a sub-component of a unified communications system, an email that is addressed to a recipient by way of a delivery address that includes a first domain identifier. Based at least in part on the delivery address, a second delivery address associated with the user is identified. The second delivery address does not include the first domain identifier but does include a second domain identifier that is different than the first domain identifier. The email is automatically sent to the second delivery address.

### BRIEF DESCRIPTION OF THE DRAWINGS

FIG. 1 is a schematic block diagram of an example of a unified communications system.

FIG. 2 is a flow chart diagram demonstrating a series of steps associated with a phone call management process.

FIG. 3 is a flow chart diagram demonstrating steps associated with a process of modifying a unified communications platform in order to enable it to support a multi-domain configuration.

FIG. 4 is a schematic block diagram of a computing device.

### DETAILED DESCRIPTION OF ILLUSTRATIVE EMBODIMENTS

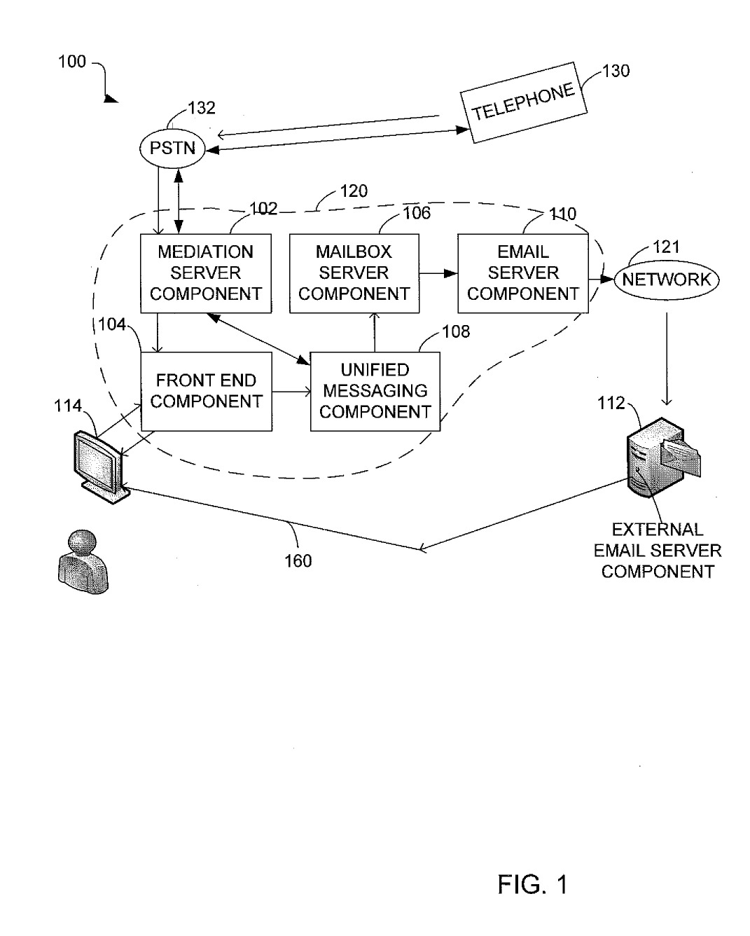

FIG. 1 is a schematic diagram of an example of a unified communications system generally identified as system 100. Components 102, 104, 106, 108 and 110 are illustrated within a dotted boundary 120. This boundary is intended to emphasize the fact that, in one embodiment, the components within the boundary are controlled and maintained by a unified communications service provider as part of a multitenant service platform. With that in mind, the circle 120 components illustratively comprise hardware and software dedicated primarily to supporting the provision of unified communications services to users from different user domains. The provided services are illustratively, but not necessarily, provided to different domains of users on a subscription fee basis.

It is to be understood that the scope of the present invention is not limited to the illustrated system 100. Without departing from the scope, the system components can be distributed in different locations, and can be hosted by any system participant. Not every component shown within boundary 120 need necessarily be in the possession or control of the unified communications service provider. In other words, any hybrid or on-premise system configuration variation should also be considered within the scope of the present invention. The illustrated configuration is provided simply for the purpose of supporting one example of an embodiment within the scope of the present invention. Those skilled in the art will appreciate that it would not be feasible to specifically illustrate every possible distribution of system components.

For the purpose of simplifying the description of FIG. 1, only one user 114 is shown as receiving the unified communications services offered in conjunction with the boundary 120 components. User 114 is illustratively one of a plurality of users aligned with one particular domain of users. Because system 100 is supports multitenant service provisioning, there are illustratively other users (not shown) aligned with different domains of users that interact with the boundary 120 components so as to receive their own unified communications services. Each user domain is essentially a different “pool” of users to which the system provides services. Of course, a particular domain might include only one user or might include hundreds or even thousands of users.

System 100 is configured such that the unified communications services provided to user 114 are provided as part of a hybrid setup. The system is hybrid in nature at least because it incorporates the functionality of an email server component 112 that is outside of boundary 120. In one embodiment, server component 112 is an on-premise email component (e.g., an email system component hosted on-premise and maintained by the customer receiving unified communications services from the unified communications service provider). In another embodiment, component 112 is an email component hosted by a third party service provider (e.g., a cloud service provider) that provides email services to user 114, or to the organization with which the user is affiliated.

FIG. 1 does not show user 114 interacting with the boundary 120 components across a computer network (e.g., the Internet or a LAN) but this is the most likely scenario. Further, in one embodiment, user 114 is actually a human user that runs, on any of a variety of different devices (e.g., a personal computer, a mobile phone, a handheld computing device, etc.), a client application through which the unified communications services are provided. This may be a simplification in that the application through which the services are provided can just as easily be provided in part or completely as part of the received services. For example, the application may be provided primarily from within the boundary 120 collection of components but accessed by user 114 utilizing an access application such as a web browser application. Alternatively, the received services can be provided through one or more client applications, such as a calendar/contact management application or even a unified communications management application.

In one embodiment, the services provided in conjunction with the boundary 120 components include a Voice-over-Internet Protocol (VoIP) solution. This illustratively enables user 114 (and other service recipients) to place, receive, forward or delegate local and long-distance calls directly from most any network connected device (e.g., from the user's PC, desk phone or mobile phone). In essence, phone service integrated into the unified communications service rather than relying upon another service provider for phone service.

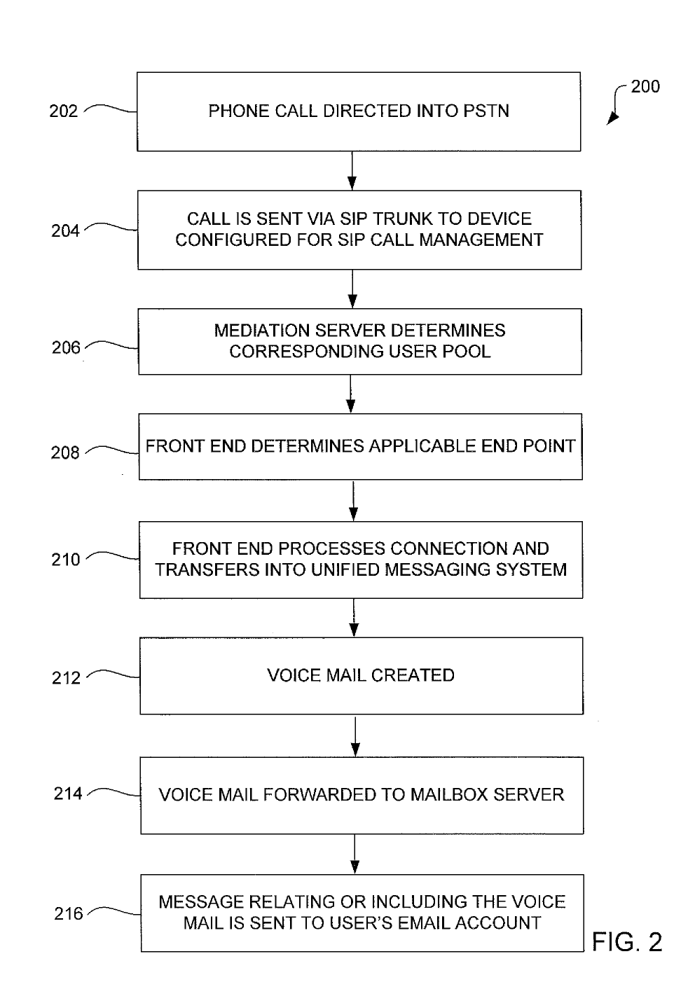

FIG. 2 is a flow chart that, in conjunction with system 100, demonstrates a series of steps associated with a phone call management process generally designated as method 200. In accordance with block 202, the process begins when a phone call is directed from a telephone 130 into the traditional Public Switched Telephone Network (PSTN) 132. For example, a caller utilizes telephone 130 to place a call by submitting 612-952-1234 into a PSTN interface, thereby requesting a corresponding connection within the telephone network. Up to this point, the call processing is consistent with placement of a traditional telephone call.

In accordance with block 204, a SIP (Session Initiated Protocol) Trunk is utilized to process the received phone call such that it is forwarded to mediation server 102, which is another one of the boundary 120 components. In order to support the SIP processing the phone call directed to the 612-952-1234 switch is translated or converted into a corresponding SIP ID.

In one embodiment, the SIP ID reflects a domain sponsored by (or otherwise under the control of) the unified communications service provider (i.e., the provider of services in conjunction with the boundary 120 components). For example, the SIP ID for the placed call might be:

+16129521234@ucserviceprovider.com

In one embodiment, assuming that the unified communications service provider offers its services in conjunction with a multitenant service architecture, the same “@ucserviceprovider.com” will illustratively be utilized even when calls are directed to different pools of users (e.g., different groups of users that independently contract with the service provider for the provision of unified communications services). That being the case, in accordance with block 206, mediation server 102 determines, based at least in part on correlation to the SIP ID, a pool of other affiliated users. Then, in accordance with block 208, front end 104 locates, from the user pool, the appropriate call end point for the users identified by the SIP ID. For that end point, the front end 104 may also determine applicable status or presence information (e.g., logged-in, not logged-in, presence status etc.).

In accordance with block 210, the front end 104 determines (e.g., based on the end point and status data) what action should be taken next in order to properly process the phone call. User 114 is illustratively the user to whom the dialed SIP ID is assigned. In one embodiment, when is determined that user 114 is unavailable (e.g., determined that he/she is not logged in, not available, not accepting phone calls, has declined to take the call, presence indicates unavailable, etc.), front end 104 facilitates a transfer of the call into voice mail sub-component of unified messaging component 108. In one embodiment, this involves moving the call into unified messaging component 108 in order to establish a media audio path and record a voice message from the caller. Block 212 represents creation of the voice mail.

In accordance with block 214, the voice mail is forwarded to mailbox server 106. Upon receipt of the voicemail, a corresponding message (e.g., an email) is created (e.g., an email containing the voice mail in the form of an audio file). In accordance with block 216, the message is forwarded to email server 110 and delivered to the user's (i.e., user 114's) email box. User 114 accesses the email by way of a client-based or hosted unified messaging and/or unified communications user interface operating on a client device. In one embodiment, this means that the message is delivered as an email to an “external contact” by way of the email server 110 (e.g., an email exchange server) and a client application for accessing messages.

For some organizations that are a pool of recipients of the unified communications services, the unified communications service provider will host the email server and email services. For example, email server 110 illustratively facilitates email processing and functions for customers as part of the delivered unified communications and unified messaging services. In one embodiment, the email functionality manages email in accordance with a scheme that involves all user pools being part of a common email domain (e.g., the same as the SIP ID—in the format of username@ucserviceprovider.com). This does not necessarily mean that, ultimately, all users must abandon their existing external email domains and start using their SIP ID as their day-to-day email domain. Those skilled in the art will appreciate that the electronic mail delivered to a SIP ID addressed mailbox can be processed such that messages directed to a SIP ID formatted mailbox are ultimately blended into a user's existing external email domain. In one embodiment, unified messaging component 108 facilitates a blending, into a common user email management interface, of messages addressed to a SIP ID formatted mailbox in with mail addressed directly to a user's day-to-day mail domain.

Accordingly, the unified communications system provided in association with the boundary 120 components utilizes the SIP ID domain within both an email context and for the purposes of facilitating the other unified communications services such as services related to voice communication. In fact, some unified communications software platforms will assume that the email domain utilized within the unified communications system is the same as the domain utilized in conjunction with other services. Utilizing a combination of different domains will often cause at least some of the unified communications services to become non-operable.

With all of this in mind, it stands to reason that, when the unified communications service receiver utilizes the “internal” email services of server 110 within the boundary 120, this simplifies things for the unified communications service provider. Under these circumstances, the unified communications service provider is likely to have excellent access and control. This simplifies the process of creating a new unified communications service solution for a new pool of users within the multitenant service architecture.

Unfortunately, for many different reasons, it is desirable for the unified communications service provider to allow a service consumer (e.g., a particular pool of users) to maintain an existing (or establish a new) external (e.g., outside of boundary 120) email service source. For the purpose of illustration, but not by limitation, such a service source is identified in FIG. 1 as external email server component 112, which is provided remotely over network 121 (e.g., the Internet). The email source 112 may be implemented in a variety of different ways without departing from the scope of the present invention. In one embodiment, email source 112 is an on-premise email server maintained in the control of the recipient of the unified communications services (i.e., in the control of an organization representing an applicable pool of users/service consumers). In another embodiment, however, server 112 is hosted by a third party email service provider (e.g., a third party email service provider) that is separate from the unified communications service provider and also separate from the recipient of the unified communications services.

This utilization of an “external” email source can complicate things for the unified communications service provider. For example, each domain of users having an external email management component is likely to have their own email domain (e.g., username@customer1.com, username@customer2.com). The unified communications software platform commonly depends upon, to a certain extent, certain presumptions as to the configuration of component 106 and/or component 110 in order to properly provide the unified communications services. Accordingly, simply functionally substituting component 112 in place of component 110 is likely to cause a failure in the provision of one or more of the unified communications services. For example, the unified communications software platform generally requires a consistency in a user's domain across the various unified communications sub-systems, a consistency that does not exist if one were to substitute in an external email component such as component 112.

One example of a unified communications platform that requires that a user's domain be consistent across both the email platform and the broader unified communications platform is Microsoft Office Communications Server 2007 R2 platform. This platform is offered by Microsoft Corporation of Redmond, Wash. In this case, utilizing user 114's component 112 email domain (e.g., username@usercompany.com) in the component 110 context is not effective because it creates an unworkable inconsistency when compared to the user 114's domain in the broader unified communications service platform (e.g., username@ucservice provider.com). This inconsistency causes a breakdown that causes certain of the unified communications platform services (e.g., certain presence, conference and desk share functions) to fail and become non-operational or at least not ideally operable.

One solution to this problem would be to make significant changes to component 112 in order to configure it to work effectively with the unified communications platform. For example, component 112 could be reconfigured so as to enable it to operate using the service receiver's email domain (e.g., @usercompany.com) while at the same time operating so as to be consistent with standard operation of component 106. However, it is not feasible for the unified communications service provider to make such changes for what very well might be a large number of different pools of users operating within the multitenant system.

Instead, in one embodiment, system components (e.g., but not necessarily limited to, unified communications platform components operating from within boundary 120) are modified so as to tolerate the domain inconsistency. Therefore, rather than utilizing just one of components 106 and 112, both components are configured to operate together in a way that allows both domains to be active. Despite the inconsistency, the system is still able to support all available functions of the unified communications platform as if there were only a single active domain. Accordingly, in one embodiment, component 110 and/or 108 are configured to send the received mail message (i.e., containing the record of the voice mail consistent with steps 214/216 in FIG. 2), to a corresponding (i.e., affiliated with the same user indicated by the SIP ID) external contact, which is illustratively the user's email account (utilizing a domain different than the SIP ID) hosted on the external mail processing component 112. The user 114 is then able to access the message, in accordance with arrow 160 in the same manner that the user accesses any other email sent to his/her external email domain. In one embodiment, the email is delivered to the user through an integrated user interface of a client application through which the unified communications services are also provided (i.e., the user does not have to access a separate mail message accessing interface).

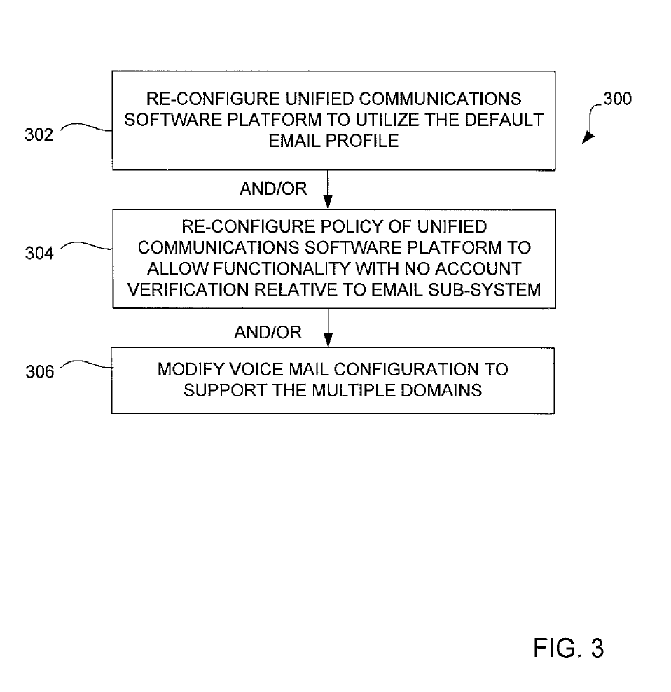

FIG. 3 is a flow chart diagram demonstrating steps associated with a process of modifying a unified communications platform in order to enable it to support the described multi-domain configuration. In accordance with block 302, changes (e.g., registration modifications) are made to the integrated services software platform in order to disable validation that would otherwise require the same domain across the email and other unified communications sub-systems. In one embodiment, the software is modified to instead use a default email profile. Examples, not by limitation, of registry changes consistent with this approach are:
Registry locations HKCU\Software\Policies\CompanyXYZ\UCSoftwareProduct\Dis ableEmailComparisonCheck HKLM\Software \Polcies\CompanyXYZ\UCSoftwareProduct\Dis ableEmailComparisonCheck
Set Registry Values 1—UCSoftwareProduct does not compare the current user's email address with the currently-loaded profile
Registry Value Type REG_DWORD

In accordance with block 304, policies within the unified communications software platform are modified so as to allow unified communications functionality without requiring an account verification relative to the email sub-system. In one embodiment, the software platform includes a default client policy set to an automatic state. In this state, it may not be possible to disable the user account validation, as was described in relation to block 302. Accordingly, in one embodiment, the system policy is changed. It is within the scope of the present invention to enable the change on the global policy or a new client policy can be created. Thus, the policy change can be made on the client level or the server level without departing from the scope of the present invention.

In one embodiment, completing steps 302 and 304 will enable a user to enjoy most unified communications services (e.g., presence, etc.) that one would have access to in the traditional single domain environment. However, additional changes may need to be made in order to effectively process and route voice mail. In accordance with block 306, in order to properly set up voice mail within the multiple user domain environment, the following steps are taken:
1) Create User Mail Box on Unified Communications Domain
2) Enable Unified Communications Domain Mailbox User for Unified Messaging
3) Create external mail contact object for the users real email address.
4) Set all mail on the Unified Communications Domain User Mailbox to be forwarded to the user's external email address.

The first two of these steps are illustratively consistent with a single user domain implementation. The third and fourth steps are specific to the multiple user domain implementation. These latter two steps are required in order to get mail messages forwarded to the user's real email address external email address.

The adjustments of FIG. 3 illustratively enable most of not all unified communications services in the multiple user domain environment. There may be minor exceptions. For example, small items might not function correctly for any of a variety of reasons. For example, there can be unforeseen data format or type inconsistencies that might arise as a result of the modifications made to accommodate the multiple user domain environment. It is within the scope of the present invention to made additional modifications to resolve these issues.

In one example, the modifications illustratively result in missed call notifications, inactive voice mail tabs, and non-functioning meeting scheduling functionality. Things like this can happen for a variety of reasons, such as when a user's sign-in name (e.g., 612-952-1234@ucserviceprovider.com) and their email alias (username@customer1.com) differ even though the mailbox has an alias that compares to the sign-in name. In one embodiment, these types of issues can be resolved by adding the SIP URI as an allowable alternative within the applicable mail processing environment (e.g., add it to the Active Directory Exchange Account on the applicable exchange environment).

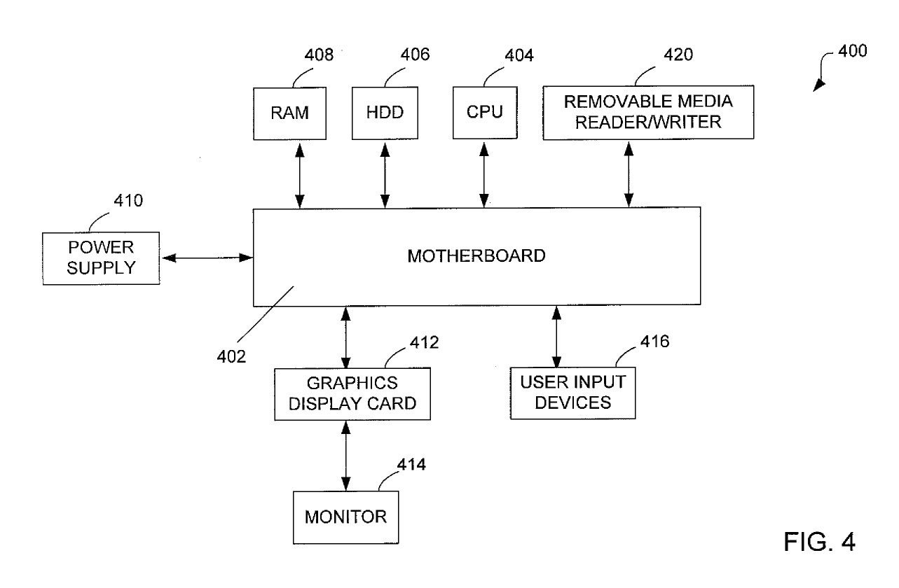

As those skilled in the art will certainly appreciate, embodiments described herein are intended for implementation in association with computing devices such as, but not limited to, a personal computer, a laptop computer, a personal digital assistant, a mobile device, a cell phone, a tablet PC or a server. FIG. 4 is a block diagram of one example of a suitable computing device 400. Computing device 400 is only one example of a suitable device and is not intended to suggest any limitation as to the scope of use or functionality of the claimed subject matter. Neither should computing device 400 be interpreted as having any dependency or requirement relating to any one or combination of illustrated components.

Computing device 400 includes a motherboard 402, a central processing unit 404, a hard disk drive 406, random access memory 408, a power supply 410, a graphics display card 412, a monitor 414, user input devices 416, a communications card 418, and removable media reader/writer 420. Hard disk drive 406 is configured to write information to, and read information from computer readable storage media. Random access memory 408 is also configured to write information to, and read information from computer readable storage media. Removable media reader/writer 420 is configured to write information to, and read information from removable media such as, but not limited to, a magnetic disk, an optical disk, and/or flash memory. User input devices 416 are configured to receive various inputs from a user. Devices 416 can include, but are not limited to, a keyboard, a mouse, a touch screen, and/or a microphone. Communications card 418 enables computing device 400 to transfer data to and from other electronic devices. Graphics display card 412 generates graphical image information and outputs the information such that it can be viewed on a monitor. Monitor 414 receives a signal from graphics display card 412 and displays visual images on its screen for a user to view. Central processing unit 404 executes computer program instructions and processes data. Motherboard 402 provides electrical and logical connections by which the other components of the system communicate. For example, motherboard 402 allows the central processing unit 404 to read data from, and write data to random access memory 408. Finally, power supply 410 provides for the electrical requirements of computing device 400. For example, electricity needed to operate hard disk drive 406 and monitor 414 illustratively originates from power supply 410.

Although the present invention has been described with reference to preferred embodiments, workers skilled in the art will recognize that changes may be made in form and detail without departing from the spirit and scope of the invention.

What is claimed is:

1. A computer-implemented method of email processing within a multitenant unified communications environment, the method comprising:
receiving, at a first email system component that is a sub-component of a unified communications system, an email that is addressed to a recipient by way of a delivery address that includes a first domain identifier;
identifying, based at least in part on the delivery address, a second delivery address associated with the user, wherein the second delivery address does not include the first domain identifier but does include a second domain identifier that is different than the first domain identifier; and
automatically sending the email to the second delivery address.

2. The method of claim 1, wherein the delivery address further comprises a series of phone number digits that at least indirectly identify the recipient.

3. The method of claim 1, wherein the email is an automatically generated email generated by a component of the unified communications system.

4. The method of claim 3, wherein the email contains a record of a voice mail received by a voice mail sub-component of the unified communications system.

5. The method of claim 2, wherein the email is automatically generated and contains a record of a voice mail recorded during a phone call connected in response to a dialing of the phone number digits.

6. The method of claim 2, wherein the email is automatically generated and contains a record of a voice mail recorded during a phone call connected in response to a connection made through a PSTN telephone network.

7. The method of claim 1, wherein automatically sending the email comprises automatically sending the email across a computer network to an email system that is different than said first email system.

8. The method of claim 7, wherein the different email system is an on-premise email system.

9. The method of claim 7, wherein the different email system is a third party hosted, cloud-based email system.

10. A computer-implemented method of providing a unified communications service, the method comprising:
providing a unified communications software platform; and
utilizing the unified communications software platform to accept, store and distribute user presence information relative to a user despite being programmed with two different domains for the user.

11. The method of claim 10, wherein one of the two different domains includes a series of digits that when dialed into a PSTN enables a phone call connection to an account of the user within the unified communications software platform.

12. The method of claim 10, wherein one of the two different domains identifies an email account outside of the unified communications software platform.

13. The method of claim 12, further comprising automatically forwarding an email containing a record of a voice mail to the email account outside of the unified communications software platform.

14. The method of claim 12, further comprising automatically forwarding an email containing a record of a voice mail across the Internet to the email account outside of the unified communications software platform.

15. A computer-implemented method of providing services within a multitenant unified communications service environment, the method comprising:
re-configuring a unified communications software platform so as to eliminate a requirement that two user domains must match in order for a particular service to function correctly; and
providing the particular service from the unified communications software platform to at least two different tenants within the multitenant unified communications service environment.

16. The method of claim 15, wherein providing the particular service comprises accepting, storing and distributing user presence information relative to a user despite being programmed with two different domains for the user.

17. The method of claim 16, wherein one of the two different domains includes a SIP ID.

18. The method of claim 16, wherein one of the two different domains is an indicator of a email account remotely hosted an email component that is separate and distinct from an additional email component that is not remotely hosted.

19. The method of claim 16, wherein re-configuring comprises making at least one registry change.

20. The method of claim 16, wherein re-configuring comprises changing at least one policy.
